(19) United States
(12) Patent Application Publication
(10) Pub. No.: US 2008/0186868 A1
(43) Pub. Date: Aug. 7, 2008

(54) Method and Apparatus Using Varying Length Training Sequences in Radio Communication

(75) Inventors: Ni Ma, Shanghai (CN); Yueheng Li, Shanghai (CN); Xuejun Zhang, Shanghai (CN); Xiaobo Zhang, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 11/814,814

(22) PCT Filed: Jan. 19, 2006
(86) PCT No.: PCT/IB06/50196

§ 371 Date: Jul. 26, 2007

(30) Foreign Application Priority Data
Jan. 31, 2005 (CN) 200510005058.6

(51) Int. Cl. H04L 12/26

(52) U.S. Cl. 370/252

(57) ABSTRACT

The present invention discloses a communication method for radio communication system, comprising the steps of detecting signals received from a mobile terminal so as to obtain detected results of a corresponding uplink channel of the received signals; determining the length criteria of training sequences in corresponding uplink bursts based on said detected results of the uplink channel; allocating predetermined uplink timeslots for said mobile terminal based on said length criteria of training sequences in the uplink bursts; and notifying said mobile terminal with said length criteria of training sequences in the uplink bursts and said uplink timeslots.

### FIELD OF THE INVENTION

The present invention relates to a radio communication system, particularly relates to a communication method and apparatus for adjusting training sequence scheme and corresponding resource allocation scheme in communication bursts.

### BACKGROUND OF THE INVENTION

In TDD CDMA system, Midamble (training sequences) is a key part of burst structure of TDD CDMA system, which is used for channel estimation. In conventional systems, Midamble is transmitted in every data burst. In slow-varying ratio channel condition, there may be no need for the frequent channel estimation. In this case, because of the frequent transmitting of Midambles (once per data-burst) less traffic data can be accommodated. In FDD mode (e.g., in WCDMA, channel estimation of a specific channel is carried by “pilot” part of each traffic TS), the “pilot” part of each traffic TS has the same function as that of Midamble in TDD mode. So CDMA system of FDD mode faces the same problem.

U.S. Pat. No. 6,724,815 disclosed a method and apparatus for increasing data rate by reduction of training data. EP0615352 disclosed Radio system using a variable length training sequence. U.S. Pat. No. 5,606,580 disclosed a method of adjusting the length of a data block in a time-division multiple access communication system. WO9716046 disclosed a variable length burst transmission over the physical layer of a multi-layer transmission format.

The change of the length of training sequences may result in interference. Different users in CDMA system use the same timeslot by different channel chips, and when the training sequences in communication bursts of different users employ different lengths, the interferences between training sequences and traffic data among multiple users occur. This problem hasn't been resolved in the prior art.

Therefore, a new method and apparatus are needed to resolve the aforementioned problem of prior art.

### OBJECT AND SUMMARY OF THE INVENTION

The object of the invention is to overcome the above-mentioned problem of prior art, to provide a new radio communication method to enhance the traffic data capacity, and to resolve the relative problems better.

The present invention provides a communication method for a radio communication system, which comprises the steps of: detecting signals received from a mobile terminal so as to obtain detected results of a corresponding uplink channel of the received signals; determining a length criteria of training sequences in corresponding uplink bursts based on said detected results of the uplink channel; allocating predetermined uplink timeslots for said mobile terminal based on said length criteria of training sequences in the corresponding uplink bursts; and notifying said mobile terminal with said length criteria of training sequences in said uplink bursts and said uplink timeslots.

The present invention further provides a network side equipment for a radio communication system, said network side equipment comprising: a network side measurement means for detecting signals received from a mobile terminal so as to obtain detected results of a corresponding uplink channel of the received signals; a network side determination means for determining the length criteria of training sequences in corresponding uplink bursts based on said detected results of the uplink channel and allocating predetermined uplink timeslots for said mobile terminal based on said length criteria of training sequences in corresponding uplink bursts; a sending means for notifying said mobile terminal with said length criteria of training sequences in said uplink bursts and said uplink timeslots.

The present invention further provides a communication method for a radio communication system, comprising the steps of: determining a length criteria of training sequences in the corresponding downlink bursts based on downlink channel detection reports from a mobile terminal; allocating predetermined downlink timeslots for said mobile terminal based on the length criteria of training sequences in said downlink bursts; notifying said mobile terminal with said length criteria of training sequences in said downlink bursts and said downlink timeslots.

The present invention further provides a network side equipment for a radio communication system, said network side equipment comprising: a network side determination means for determining length criteria of training sequences in the corresponding downlink bursts based on a downlink channel detection report from a mobile terminal and allocating predetermined downlink timeslots for said mobile terminal based on the length criteria of training sequences in said downlink bursts; a sending means for notifying said mobile terminal with said length criteria of training sequences in said downlink bursts and said downlink timeslots.

The present invention further provides a mobile terminal for a radio communication system, said mobile terminal comprising: a receiving means receiving notification from a network side equipment, the notification including length criteria of training sequences in bursts and the allocation of timeslots, and an adjusting means for setting the training sequences based on the length criteria of training sequences in bursts and the allocation of timeslots.

According the present invention, the length criteria of training sequences in data bursts is changed according to the variation of channel quality, consequently the saved radio resource can be used to carry more traffic data so as to enhance traffic data capacity. Applying the present invention, the timeslots allocation strategy can be adjusted according to the length of training sequences in bursts, thus resolving the interference problem caused by the variation of length criteria of training sequence in data bursts.

Other objectives and advantages of the present invention will be more apparent and understood from the following description and claims taken in conjunction with the accompanying drawings.

### BRIEF DESCRIPTION OF THE DRAWINGS

Description is made below regarding preferable embodiments of the present invention with reference to the appended drawings, in which:

FIG. 1 shows the subframe structure of TD-SCDMA.

FIG. 2 shows the time slot structure of TD-SCDMA.

FIG. 3 shows interferences between Midamble and traffic data in the case of a plurality of user equipments using different length of Midamble.

FIG. 4 shows special TS allocated for a user equipment using Midamble of zero length (without Midamble) in data bursts, according to an embodiment of the present invention.

FIG. 5A is a flowchart that represents a training sequence scheme in uplink TS bursts, according to an embodiment of the present invention;

FIG. 5B is a flowchart that represents a training sequence scheme in downlink TS bursts, according to an embodiment of the present invention;

FIG. 6 is a diagram for configuration of the function means of UE and Network according to an embodiment of the present invention.

The same reference characters in the drawings designate the same or corresponding features or functions throughout the figures thereof.

### DETAILED DESCRIPTION OF THE INVENTION

Description is made below regarding exemplary embodiments of the present invention with reference to the appended drawings.

Description of the principle of the present invention is made below.

As to uplink bursts, according to one of the communication methods of the invention, firstly, we detects received signals from a mobile terminal so as to obtain detected results of a corresponding uplink channel of the received signals; next, determines the length criteria of training sequences in corresponding uplink bursts based on said detected results of the uplink channel; next, allocates predetermined uplink timeslots for said mobile terminal based on said length criteria of training sequences in the corresponding uplink bursts; and next, notifies said mobile terminal with said length criteria of training sequences in the uplink bursts and said uplink timeslots.

As to downlink bursts, according to one of the communication methods of the invention, firstly, we determines the length criteria of training sequences in the corresponding downlink bursts based on a downlink channel detection report from a mobile terminal; next, allocates predetermined downlink timeslots for said mobile terminal based on the length criteria of training sequence in said downlink burst; next, notifies said mobile terminal with said length criteria of training sequences in the corresponding downlink bursts and said downlink timeslots.

The length criteria of the communication method according to the present invention includes the length of training sequences, and can also includes a time interval in which said length of training sequence is used continuously. The length of training sequences in the same length criteria is same or similar. The length of training sequences can be changed during the process of communication according to the detected results of channel quality so as to obtain different length criteria of training sequences in communication bursts sent or received by user equipments. In the case that the length of training sequence is not zero, the number of the mobile terminals of which the length of training sequences in the same timeslot is zero can be changed based on the detected results of channel quality. The channel detection can include SIR, SNR, or SNIR.

The radio communication system according to the present invention is performed with a CDMA mobile communication system as an example.

In the following description, the method of the present invention is illustrated by using Midamble (i.e. training sequence) in bursts as an example.

Midamble is a key part of burst structure in TDD CDMA system, which is used for channel estimation. In conventional system, Midamble is transmitted once per data-burst. The method proposed by the present invention is to adjust the length criteria of Midamble based on the channel quality. For example, the length of Midamble can be adjusted to be L, 0, or ½L. The concept of length criteria can also include the time interval in which a training sequence of a certain length (Midamble) is used continuously. For example, several continuous subframes use training sequences with the length of L, 0, or ½L. Description will be made below regarding the case of sending the training sequences with the length of L and 0 alternatively as an example. For example, if the channel quality is stable, as to the bursts in multiple continuous subframes, the bursts in the following subframes can use the channel estimation obtained based on the previous bursts. Accordingly, in the bursts in multiple subframes, users can send Midamble intermittently, that is to say, the length of the training sequence in one of the bursts in a cycle is L (the length is not zero), and the length of the training sequences in the bursts of other subframes is zero. In the disclosure according to the present invention, the length of training sequences or the cycle in the previous example is determined by networks based on the detected results. The present invention further provides signalling procedures associated with the related scheme. When more than one UE use different length criteria of Midamble, the scheme according to the invention can avoid the interferences between Midamble and other users' data by allocating different timeslots for the UEs having the same length criteria of Midamble.

In the rest of this application, we will take TD-SCDMA as an example to provide the necessary information about TDD system and to depict our new ideas. In fact, what we describe here, after some necessary alterations, can be generalized to HCR (7.68 Mchip/s) cases and other TDD CDMA systems without any problem. Also the same idea can be extended to FDD mode via some necessary revision.

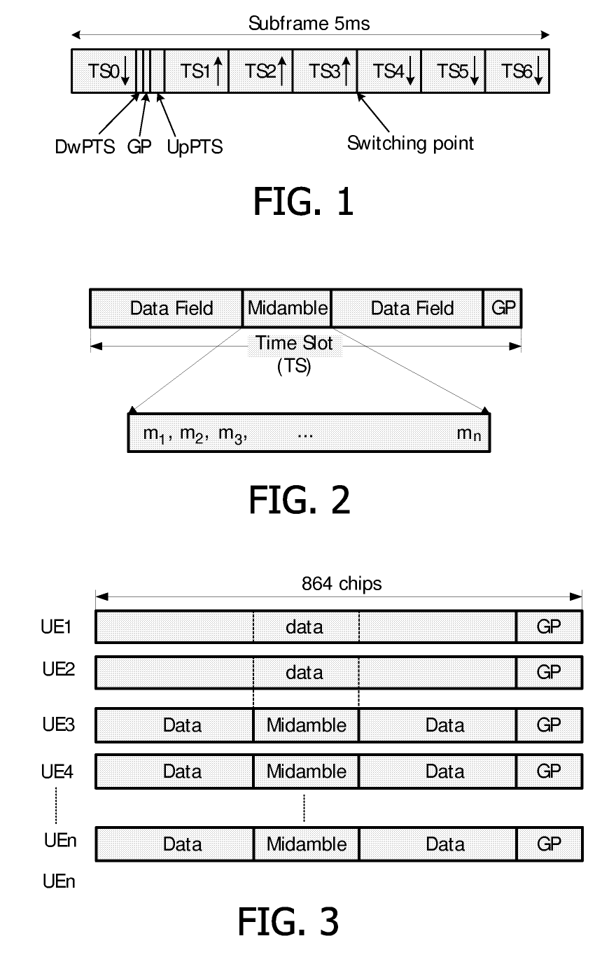

In TDD CDMA mobile cellular system, signal transmission is conducted by “radio frame”. The radio frame is further divided into Timeslots (TS) to carry information. In TD-SCDMA system, the length of one radio frame is 10 ms and it is divided into 2 same subframes of 5 ms. In each subframe, there are totally 7 normal TSs and 3 special TSs. FIG. 1 shows the subframe structure of TD-SCDMA, where TS0 and TS1 are always designated as downlink and uplink TSs respectively and are used for uplink bursts and downlink bursts respectively. DwPTS (Downlink Pilot Time Slot) and UpptS (Uplink Pilot Time Slot) are the dedicated downlink and uplink pilot TSs used for downlink and uplink synchronization respectively, and GP (Guard Period) is the guard period.

In each TS as shown in FIG. 2, there are three fields, data part, Midamble and the GP to distinguish the different TS. Midamble (m₁, m₂, m₃, . . . , mₙ, n is the Midamble length in the unit of chips) is used to estimate the channel status.

The following description is made regarding the spirit of the invention, which is to change the Midambles' transmitting frequency by using the cases that the training sequence length in the length criteria is L or zero, to adapt to channel status. When the UE or BS (Base Station) has better channel quality (e.g. channel characters vary slowly), we needn't transmit Midamble in every data bursts and can use previous channel estimation for those no-Midamble(the Midamble length is zero) data bursts. However, this change should be associated with a series of signalling procedures, e.g., channel status measurement and report, notification of parameter variation, etc. Regarding the UEs simultaneously being active in one TS, in order to eliminate the interference between local Midamble and other users' data, some schemes have been proposed in this invention. In next section, we will describe an complete procedure about these Midamble length criteria.

The following description will be made regarding how to change Midamble's transmitting frequency by using the scheme of the present invention.

In the implementation of this invention, the Midambles' transmitting frequency is changed according to the measured radio link quality. If the measured radio channel condition is good or channel is little time-variant (channel characters vary slowly), we are able to decrease midambles' transmitting frequency then use saved radio resource to carry more traffic data. The adjusted Midambles' transmitting frequency parameter (TS allocation etc.) is calculated in the network according to the measured results and then transmitted to UE through network downlink signalling.

The above-mentioned Midamble's transmitting frequency is a specific implement of length criteria of training sequence. According to the concrete embodiment described herein, the Midamble's transmitting frequency is changed, some subframes sends Midamble (the length is L), while some subframes don't send Midamble (the length is zero). We can also say that, Midamble's transmitting cycle varies. There are the subframes with Midamble and the subframes without Midamble in one cycle. That is to say, in one cycle, the Midamble's length in some time intervals is not zero, while that in some time intervals is zero.

Taking the scenario of Midambles' (training sequence) transmitting period vs. measured radio link quality as an example, we can set the different Midambles' transmitting period relevant to the different signal quality criteria, as is described in Table 1.

TABLE 1
Midamble transmitting period vs. radio link status.

| Radio link status indication | | |
|---|---|---|
| (Could be SIR, SNR, SNIR, | | |
| or other criteria, etc., | | |
| which will be initialized | | |
| by the network side.) | Midambles' transmitting period | Note |
| T₀ (Assumed baseline | The prescriptive transmitting | i and j could be |
| of the threshold) | period F: During every F data | determined by network |
| | bursts midamble is transmitted | side. The observation of |
| | once. | channel change |
| Measured radio link | Increasing above transmitting | (time-variant or little |
| status indication T is | period to be F′ (e.g., | time-variant) is also |
| better than T₀ in a | F′ = F + i, (i = 1, 2, 3 . . . )). | conducted by the network |
| measurement cycle. | | side. |
| Measured T is worse | Decreasing above transmitting | |
| than T₀ in a | period to be F″ (e.g., | |
| measurement cycle. | F″ = F − j, j = 1, 2, 3 . . . ). | |
| Measured T is very | Don't change current Midambles' | |
| approximate to T₀. | transmitting frequency. | |

The following description will be made regarding the scheme proposed for multiple UEs that simultaneously occupy one TS.

The following is the emerging problems when changing Midamble field.

As a matter of fact, mobile terminal dose not move so fast and/or channel condition does not change so frequently in many cases, therefore frequently transmitting Midamble is unnecessary and wastes the radio resource in a sense. The proposed Midamble principle can save radio resource remarkably in the case that only one UE occupies a TS. However, if more than one UE share the same TS and adjust their Midambles' transmitting frequency according to the channel qualities, there are two new problems that must be resolved.

The first problem is the downlink interference between Midamble and traffic data.

Based on the proposed principle, downlink Midambles' transmitting frequency should be changed according to the transmission environment. However, in the slot with more than one UE, interference between Midamble and traffic data will arise if Midambles are transmitted to some UEs while not to others.

The second problem is the uplink interference between Midamble and traffic data.

Same as Downlink, uplink interference will also arise during the slot with more than one UE if some UE transmit Midambles while others don't.

FIG. 3 shows how the interference occurs (both DL and UL). Assuming UE1 and UE2 don't transmit Midamble while UE3-UEn send Midamble in the same slot. We can see that UE3-UEn's Midamble and the corresponding data of UE1 and that of UE2 interfere with each other. The interference may result in that receiver can't demodulate UE1's data and UE2's data, and can't estimate UE1's channel parameters and UE2's channel parameters correctly.

In order to resolve above problems, some complementary solutions were proposed aiming at the situation that more than one UE occupy one slot.

One scheme is to allocate special timeslots for the UEs with same or similar Midamble length (e.g. the Midamble length is zero) in bursts.

As to uplink burst, firstly, we detects a received signal from a UE so as to obtain detected results of a corresponding uplink channel of the received signal; next, determines Midamble's length criteria in a corresponding uplink burst based on said detected results of uplink channel; next, allocates predetermined uplink timeslots for said UE based on said length criteria of training sequence in the corresponding uplink burst; and finally, notifies said UE with said Midamble's length criteria in the uplink burst and said uplink timeslots.

As to downlink burst, firstly we determines Midamble's length criteria in the corresponding downlink burst based on a downlink channel detection report from a UE; next, allocates predetermined downlink timeslots for said UE based on the Midamble's length criteria in said downlink burst; finally, notifies said UE with said Midamble's length criteria in the downlink burst and the allocated downlink timeslots.

In order to avoid UL and DL interference between Midamble and traffic data from different transmitters, we can allocate special no-Midamble timeslots (both DL and UL) for those data bursts without Midamble. In these special TS, no Midambles are transmitted, so interference doesn't exist.

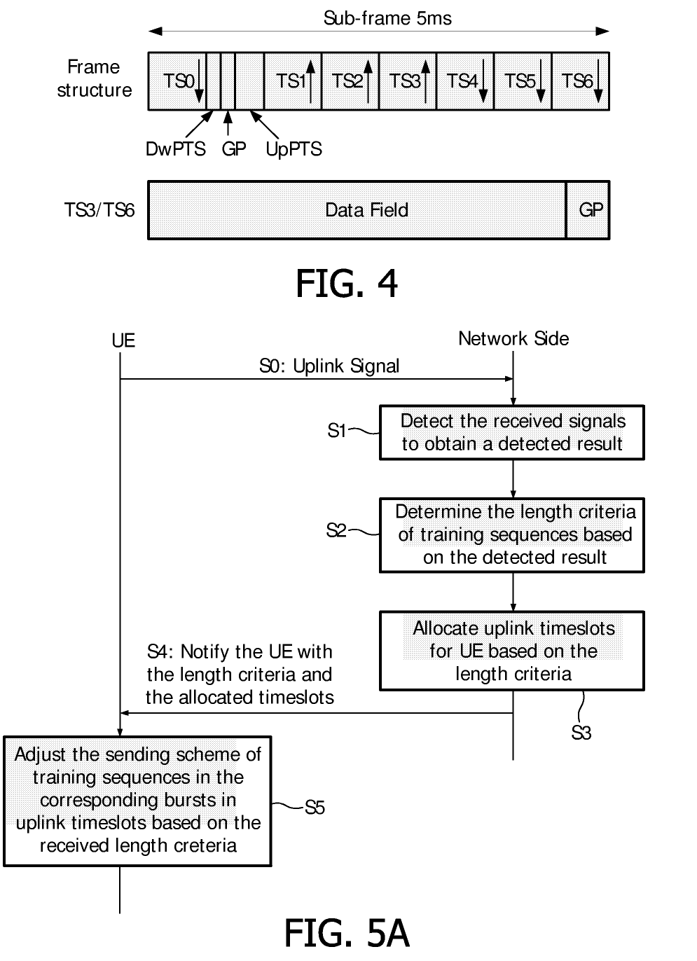

As shown in FIG. 4, we can allocate one UL (e.g. TS3) and one DL (e.g. TS6) timeslot respectively as no-Midamble TS. For those UEs in good transmission environment, they occupy a normal TS when transmitting/receiving data including Midamble, and employ TS3/TS6 when transmitting/receiving no-Midamble data.

Note that more no-Midamble TSs can be allocated by UTRAN (UMTS Terrestrial Radio Access Network, UTMS (Universal Mobile Telecommunication System)) if more UEs have good channel quality and have lower midambles' transmitting frequencies. System capacity will be increased with the added number of no-Midamble TSs.

According to the approach proposed by the invention, as to the case that only a few UEs occupy one timeslot, interference can be reduced by the scheme of adjusting the number of the no-Midamble to increase transmission data rate.

As shown in FIG. 3, assuming UE1 and UE2 transmit data while other UEs transmit Midamble in the same TS, data of UE1 and UE2 can be regarded as noise for other UEs when they carry out their channel estimation. Because the noise only comes from two UEs, the noise may be endurable for other UEs to get their channel characters. FIG. 3 takes the case of two UEs employing the scheme of this invention as example. The number of UEs employing this scheme can be practically and appropriately increased or reduced according to QoS requirements.

For UE1 and UE2, other UEs' Midambles are also regarded as noise in detecting their data fields. As the document M. J. Juntti and B. AaZhang, “Finite Memory-Length Linear Multiuser Detection for Asynchronous CDMA Communications”, IEEE Trans. Commu., Vol. 45, no. 5, May 1997, pp. 611-622 has proposed: in the case that more than 6-8 symbols are finally transferred to ZF-BLE (zero-forced block linear equalizer), interferential symbols (produced due to multi paths and asynchrony) inside the processing window of multi-user detector almost bring no influence on detection result. So if suitably dividing the no-Midamble data bursts into two groups (each group is more than 8 symbols), other UEs' Midamble can be regarded as multi-paths interference. By transferring the data groups to ZF-BLE respectively, we can neglect other UEs' interference of midambles on UE1 and UE2.

The following description will be made regarding the overall description about the proposed scheme.

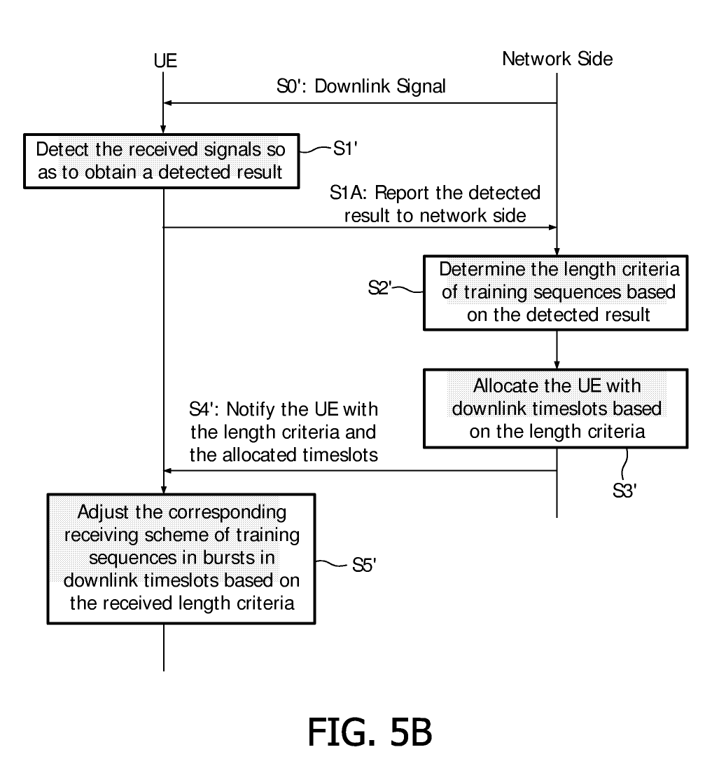

FIG. 5A is a flowchart that represents a training sequence scheme in uplink TS bursts, according to an embodiment of the present invention. FIG. 5B is a flowchart that represents a training sequence scheme in downlink TS bursts, according to an embodiment of the present invention.

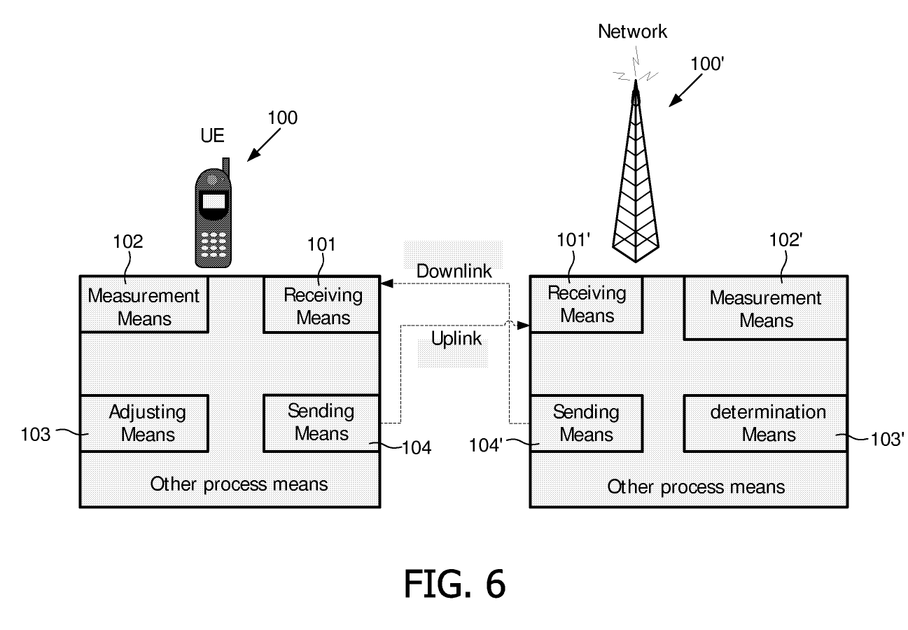

FIG. 6 shows the configuration of the process means according to the present invention, wherein, network side equipment 100′ includes: a receiving means 101′, a measurement means 102′, a determination means 103′, and a sending means 104′. Mobile terminal UE100 includes: a receiving means 101, a measurement means 102, an adjusting means 103, and a sending means 104.

The operating steps and function means will be depicted in conjunction with FIG. 5A, 5B and FIG. 6. Since Midamble's transmitting frequency changes with actual radio transmission environment, the signalling procedures associated with the scheme of Midamble's length criteria are necessary. Compared with conventional schemes, the configuration of process devices in UE and network side should be changed in a new scheme.

According to an embodiment of the invention, the receiving means 101′ receives signals from UE100 (corresponding to step S0 in FIG. 5A), and the measurement means 102′ detects the received signals from UE100 so as to obtain detected results of uplink channel corresponding to said received signals (performing the function of S1 in FIG. 5A). The determination means 103′ determines the corresponding Midamble in uplink bursts, i.e. the length criteria of training sequences, based on the detected result of the uplink channel, so as to change the transmitting length, and alternatively, to change the time intervals in which said length of training sequences is continuously employed (completing the function of step S2 in FIG. 5A). The determination means 103's allocates the predetermined uplink TS for UE100 (performing step S3 in FIG. 5A). The sending means 104′ notifies UE100 with the Midamble's transmitting frequency in the uplink bursts and the uplink TSs (performing the function of step S4 in FIG. 5A).

Besides, according to a further embodiment of the invention, in network side equipment 100′ for radio communication system, the receiving means 101′ receives a downlink channel detection report from UE100 (performing the function of step S1A in FIG. 5B). The determination means 103′ determinates the length criteria of Midamble, i.e. training sequences, for changing the Midamble's length criteria in the downlink bursts (performing the function of step S2′ in FIG. 5B). The determination means 103′ allocates UE100 with the predetermined downlink TSs based on the Midamble's length criteria in the downlink bursts (performing the function of step S3′ in FIG. 5B). The sending means 104′ notifies UE100 with the Midamble's length criteria in the downlink bursts and said downlink TSs (performing the function of step S4′ in FIG. 5A).

The mobile terminal UE100 for radio communication system includes: a receiving means 101, an adjusting means 103, a measurement means 102, and a sending means 104. The receiving means 101 receives the notification from network side equipment (corresponding to the function on the receiving side of steps S4 and S4′ in FIG. 5A and FIG. 5B), the notification including said Midamble's length criteria and the allocation of TSs. The adjusting means 103 receives or sends the bursts based on the Midamble's length criteria and the allocation of TSs in the received notification (corresponding to the function of steps S5 and S5′ in FIG. 5A and FIG. 5B). The measurement means 102 detects the downlink channels to obtain a downlink detection report (performing the function of step S1′ in FIG. 5B). The sending means 104 sends the detection report to network side equipment 100′(performing the corresponding function of S1A in FIG. 5B).

The length of training sequences in bursts can be any decided length, including zero and the conventional length L. The following description only takes the case that the length is zero and L alternatively (i.e. Midamble's transmitting frequency) as example.

The set of length criteria of training sequences changes the Midamble's transmitting frequency. According to the above specific implement, the Midamble's transmitting frequency is changed, and some subframes send Midamble while some don't. We can also say that Midamble's transmitting cycle is changed. There are subframes with Midamble and those without Midamble.

We can see from FIG. 5A and FIG. 5B that, the length criteria of training sequences in uplink bursts and downlink bursts and the corresponding TS resource are determined based on the detected results by the network side, and sent to the mobile terminal over downlink. Since the features of downlink and uplink are symmetric in TDD system basically, the measured result of uplink is almost consistent with that of downlink. Accordingly, the network side equipment 100′ can determine the Midamble's length criteria in uplink to determine the transmitting frequency thereof accordingly.

The following description is made regarding extending the invention to FDD mode.

In FDD mode (e.g., in WCDMA, channel estimation of dedicated channel is carried out by “pilot” part of each traffic TS), the “pilot” part has the same function as the Midamble of the TDD mode. So the idea of this invention can be applied to FDD mode. Due to different channel characteristic of uplink and downlink in FDD, UE100 determines the length criteria of Midambles of uplink via the adjusting means 103 based on the measured result of the measurement means 102, the network side equipment 100′ determines the length criteria of Midambles of downlink via the determination means 103′ based on the measured result of the measurement means 102′.

Within the spirit and the scope of this invention, there can be many changes or modifications. It should be understood that this invention is not limited to specific embodiments. The scope of this invention is defined by the appended claims.

1. A communication method for radio communication system, comprising the steps of:
(a) Detecting signals received from a mobile terminal so as to obtain detected results of a corresponding uplink channel of the received signals;
(b) Determining a length criteria of training sequences in corresponding uplink bursts based on said detected results of the uplink channel;
(c) Allocating predetermined uplink timeslots for said mobile terminal based on said length criteria of training sequences in the corresponding uplink bursts; and
(d) Notifying said mobile terminal with said length criteria of training sequences in the uplink bursts and said uplink timeslots.

2. The communication method according to claim 1, wherein, said length criteria includes the length of training sequences.

3. The communication method according to claim 2, wherein, said length criteria further includes time intervals in which said length of said training sequences is continuously employed.

4. The communication method according to claim 2, wherein, the length of training sequences in the same length criteria is the same.

5. The communication method according to claim 2, wherein, the length of training sequences is zero.

6. The communication method according to claim 5, further comprising the steps of changing the number of mobile terminals of which the training sequences length is zero in said radio communication system, based on the detected results.

7. The communication method according to claim 2, wherein, all of the communication bursts have the same length criteria of training sequences in said predetermined uplink time slots.

8. The communication method according to claim 1, wherein, detection of uplink channels includes SIR, SNR, or SNIR.

9. The communication method according to claim 1, wherein, said radio communication system is CDMA mobile communication system.

10. A network side equipment for radio communication system, comprising:
a network side measurement means for detecting signals received from a mobile terminal so as to obtain detected results of a corresponding uplink channel of the received signals;
a network side determination means for determining a length criteria of training sequences in the uplink bursts based on said detected results of the uplink channel and allocating predetermined uplink timeslots for said mobile terminal based on said length criteria of training sequences in the uplink bursts;
a sending means for notifying said mobile terminal with said length criteria of training sequences in the uplink bursts and said uplink timeslots.

11. The network side equipment according to claim 10, wherein, said length criteria includes the length of training sequences.

12. The network side equipment according to claim 11, wherein, said length criteria further includes time intervals in which said length of said training sequences is continuously employed.

13. The network side equipment according to claim 11, wherein, the length of training sequences in the same length criteria is the same.

14. The network side equipment according to claim 11, wherein, the length of training sequences is zero.

15. The network side equipment according to claim 14, wherein said network side equipment further changes the number of mobile terminals of which the training sequences length is zero in said radio communication system, based on the detected results.

16. The network side equipment according to claim 11, wherein, all of the communication bursts have the same length criteria of training sequences in said predetermined uplink time slots.

17. A communication method for radio communication system, comprising the steps of:
(a) Determining a length criteria of training sequences in the corresponding downlink bursts based on downlink channel detection reports from a mobile terminal;
(b) Allocating predetermined downlink timeslots for said mobile terminal based on the length criteria of training sequences in said downlink bursts;
(c) Notifying said mobile terminal with said length criteria of training sequences in the downlink bursts and said downlink timeslots.

18. The communication method according to claim 17, wherein, said length criteria includes the length of training sequences.

19. The communication method according to claim 18, wherein, said length criteria further includes time intervals in which said length of said training sequences is continuously employed.

20. The communication method according to claim 18, wherein, the length of training sequences in the same length criteria is the same.

21. The communication method according to claim 18, wherein, the length of training sequences is zero.

22. The communication method according to claim 21, further comprising the steps of changing the number of mobile terminals of which the training sequences length is zero in said radio communication system, based on the detected results.

23. The communication method according to claim 18, wherein, all of the communication bursts have the same length criteria of training sequences in said predetermined uplink time slots.

24. The communication method according to claim 17, further comprising the step of receiving a downlink channel detection report from a mobile terminal.

25. A network side equipment for radio communication system, comprising:
a network side determination means for determining length criteria of training sequences in the corresponding downlink bursts based on a downlink channel detection report from a mobile terminal and allocating predetermined downlink timeslots for said mobile terminal based on the length criteria of training sequences in said downlink bursts;
a sending means for notifying said mobile terminal with said length criteria of training sequences in the downlink bursts and said downlink timeslots.

26. The network side equipment according to claim 25, further comprising a receiving means for receiving a downlink channel detection report from a mobile terminal.

27. A mobile terminal for radio communication system, said mobile terminal comprising:
a receiving means for receiving notification from a network side equipment, the notification including length criteria of training sequences in bursts and the allocation of timeslots, and
an adjusting means for receiving or sending bursts based on the length criteria of training sequences in bursts and the allocation of timeslots in the received notification.

28. The mobile terminal according to claim 27, said mobile terminal further comprising:
a detection means for detecting downlink channels to obtain a downlink channel detection report,
a sending means for sending the detection report to a network side equipment.
